(19) United States
(12) Patent Application Publication
(10) Pub. No.: US 2015/0013799 A1
(43) Pub. Date: Jan. 15, 2015

(54) COMPONENT ATTACHING STRUCTURE AND PRESSURE REGULATOR

(71) Applicants: Yohei Ono, Aichi-ken (JP); Naohito Sarai, Aichi-ken (JP)

(72) Inventors: Naohito Sarai, Nagoya-shi (JP); Yohei ONO, Nisshin-shi (JP)

(73) Assignees: AISAN KOGYO KABUSHIKI KAISHA, Aichi-ken (JP); Toyota Jidosha Kabushiki Kaisha, Aichi-ken (JP)

(21) Appl. No.: 14/324,846

(22) Filed: Jul. 7, 2014

(30) Foreign Application Priority Data
Jul. 9, 2013 (JP) 2013143624

(51) Int. Cl. F16L 15/04; F16K 15/18

(52) U.S. Cl. CPC F16L 15/04; F16K 15/18
USPC 137/614.2; 285/355

(57) ABSTRACT

A component attaching structure for attaching a first component and a second component to each other. The first component has an attachment hole and an internal thread formed therein. The second component has an external thread formed thereon. The second component supports a sealing member, which seals an interface between an outer circumferential surface of the second component and an inner circumferential surface of the attaching hole at a position closer to a tip end of the second component than the external thread. If the direction in which the second component moves relative to the first component when the second component is attached to the first component is defined as an attaching direction, a distance between the external thread and the sealing member in the attaching direction is greater than the length of the internal thread in the attaching direction.

### RELATED APPLICATIONS

This Application claims the benefit of Japanese Application No. 2013-143624 filed Jul. 9, 2013, said prior application being hereby fully incorporated by reference herein.

### BACKGROUND OF THE INVENTION

The present invention relates to a component attaching structure for attaching a first component and a second component to each other by screwing an external thread of the second component into an internal thread of the first component, and to a pressure regulator in which a pressure control valve and a shut-off valve are integrated.

A pressure regulator as disclosed in Japanese Laid-Open Patent Publication No. 2002-182751 is provided in a supply passage, through which gaseous fuel such as compressed natural gas (CNG) is supplied to an internal combustion engine. Such a pressure regulator includes a shut-off valve, which operates to permit or inhibit supply of the gaseous fuel to a downstream supply passage, and a reducing valve, which reduces the pressure of the gaseous fuel to a specified pressure. U.S. Pat. No. 6,629,544, which is the U.S. counterpart to Japanese Laid-Open Patent Publication No. 2002-182751, is hereby fully incorporated herein by reference.

With reference to FIG. 9, an attaching structure for attaching a shut-off valve 110 to a body 101 of a pressure regulator is described. As depicted in FIG. 9, an attaching hole 102 is formed in the body 101. An internal thread 103 is formed in the inner circumferential surface of the attaching hole 102. The outer circumferential surface of an attached portion 111 of the shut-off valve 110 includes an external thread 112. The shut-off valve 110 is attached to the body 101 by screwing the external thread 112 into the internal thread 103 when the attached portion 111 is inserted into the attaching hole 102.

Gaseous fuel flows from upstream into the attaching hole 102 of the body 101. If the shut-off valve 110 is open, the gaseous fuel that has flowed into the attaching hole 102 flows out to the downstream side. It is preferrable that leakage of the gaseous fuel from the interface between the inner circumferential surface of the attaching hole 102 and the outer circumferential surface of the attached portion 111 of the shut-off valve 110 be restricted to restrict the leakage of the gaseous fuel from the inside of the attaching hole 102 to the outside of the body 101.

In this regard, in the above pressure regulator, the attached portion 111 of the shut-off valve 110 supports an annular sealing member 113 at a position closer to the tip end of the shut-off valve 110 than the external thread 112. The sealing member 113 is brought into contact with the inner circumferential surface of the attaching hole 102, which is positioned deeper than the internal thread 103. This seals the interface between the inner circumferential surface of the attaching hole 102 and the outer circumferential surface of the attached portion 111.

In the case where the shut-off valve 110 is attached to the body 101, foreign matter such as chips may be generated when the external thread 112 is screwed into the internal thread 103. The foreign matter may adhere to the sealing member 113 and the inner circumferential surface of the attaching hole 102. At this time, if the foreign matter enters the interface between the sealing member 113 and the inner circumferential surface of the attaching hole 102, the sealing property of the sealing member 113 between the inner circumferential surface of the attaching hole 102 and the outer circumferential surface of that attached portion 111 may be reduced.

### SUMMARY OF THE INVENTION

An objective of embodiments of the present invention is to provide a component attaching structure and a pressure regulator, which improve the sealing property between an inner circumferential surface of an attaching hole of a first component and an outer circumferential surface of a second component.

According to an aspect of embodiments of the present invention, a component attaching structure for attaching a first component and a second component to each other is provided. The first component has an attachment hole and an internal thread formed in an inner circumferential surface of the attaching hole. The second component has an external thread formed on an outer circumferential surface thereof. The component attaching structure is configured such that the second component can be attached to the first component by screwing the external thread of the second component into the internal thread of the first component. The second component supports a sealing member, which seals an interface between the outer circumferential surface of the second component and the inner circumferential surface of the attaching hole at a position closer to a tip end of the second component than the external thread. If the direction in which the second component moves relative to the first component when the second component is attached to the first component is defined as an attaching direction, a distance between the external thread and the sealing member in the attaching direction is greater than a length of the internal thread in the attaching direction.

According to another aspect of embodiments of the present invention, a pressure regulator adapted to be provided in a supply path through which gaseous fuel is supplied to an internal combustion engine is provided. The pressure regulator includes a body, a reduced valve, a shut-off valve, and a sealing member. The body has an attaching hole and an internal thread formed in an inner circumferential surface of the attaching hole. The reducing valve has a housing and an external thread formed in an outer circumferential surface thereof. The reducing valve reduces a pressure of a gas that has flowed into the body. The shut-off valve permits and inhibits the supply of gas to a downstream side. The sealing member seals an interface between the inner circumferential surface of the attaching hole and the outer circumferential surface of the housing. The shut-off valve is attached to the body when the external thread of the shut-off valve is screwed into the internal thread of the body. The housing of the shut-off valve supports the sealing member at a position closer to a tip end of the shut-off valve than the external thread to the tip end. The distance between the external thread and the sealing member in an axial direction of the shut-off valve is greater than the length of the internal thread in the axial direction.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram illustrating a supply system, which includes a pressure regulator according to a first embodiment, and an internal combustion engine operated by receiving CNG from the supply system;

FIG. 2 is a cross-sectional view schematically illustrating the pressure regulator according to the first embodiment;

FIG. 3 is an enlarged cross-sectional view illustrating a part of a body of the pressure regulator, to which a shut-off valve is attached, and surroundings of the part;

FIG. 4 is an enlarged cross-sectional view illustrating a mounting recess of the body and surroundings of the recess in the pressure regulator;

FIG. 5 is a diagram illustrating a state in which the shut-off valve is attached to the body in the pressure regulator;

FIG. 6 is a diagram illustrating a state in which the shut-off valve is attached to the body in the pressure regulator;

FIG. 7 is a cross-sectional view illustrating a state in which a valve is attached to a drain tank by an attaching structure according to a second embodiment;

FIG. 8 is a diagram illustrating a state in which the valve is attached to the drain tank by the attaching structure according to the second embodiment; and

FIG. 9 is an enlarged cross-sectional view illustrating a part of a body of a conventional pressure regulator to which a shut-off valve is attached and surroundings of the part.

### DETAILED DESCRIPTION OF THE PREFERRED EMBODIMENTS

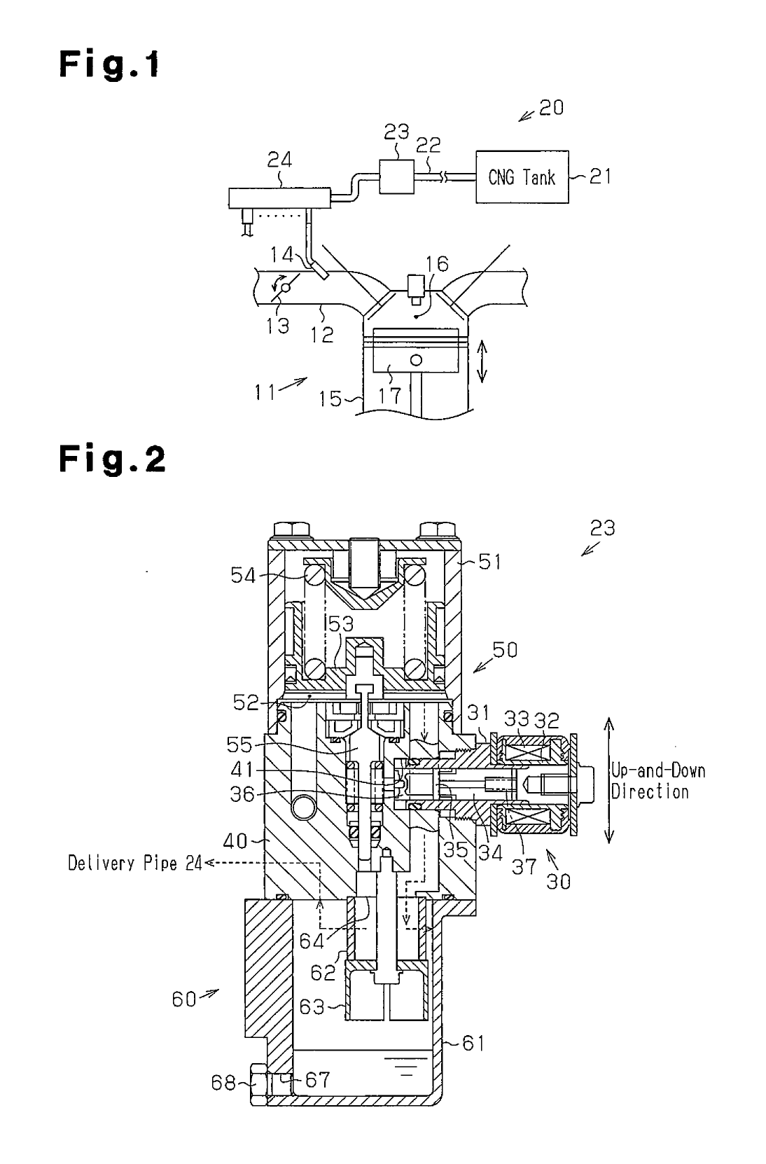

Hereinafter, a component attaching structure and a pressure regulator according to a first embodiment will be disclosed according to FIGS. 1 to 6.

FIG. 1 depicts a supply system 20 and an internal combustion engine 11. The supply system 20 supplies the internal combustion engine 11 with compressed natural gas (CNG) as an example of gaseous fuel. The internal combustion engine 11 is operated when the CNG is supplied to the internal combustion engine 11. As depicted in FIG. 1, the internal combustion engine 11 includes an intake passage 12. The intake passage 12 includes a throttle valve 13, by which an opening is adjusted in accordance with the accelerator operation by the driver, and an injector 14, which injects the CNG supplied from the supply system 20. The gaseous mixture formed by the intake air that has passed through the throttle valve 13 and the CNG that has been injected through the injector 14 burns in a combustion chamber 16 in a cylinder 15. Accordingly, a piston 17 reciprocates so that the crankshaft, which serves as an output shaft of the internal combustion engine 11, rotates in a predetermined rotation direction.

The supply system 20 includes a high-pressure fuel line 22, which serves as a supply path connected to a CNG tank 21 for storing the CNG. The pressure of the CNG, which flows in the high-pressure fuel line 22, is reduced to a predetermined fuel pressure by the pressure regulator 23 according to the present embodiment, and the CNG after the reduction of the pressure is supplied to a delivery pipe 24. The CNG supplied through the delivery pipe 24 is injected through the injector 14 into the intake passage 12.

Next, with reference to FIG. 2, the pressure regulator 23 according to the present embodiment will be described. Here, the description will be given assuming that the up-and-down direction in FIG. 2 corresponds to the vertical direction.

As depicted in FIG. 2, the pressure regulator 23 includes an electromagnetic shut-off valve 30, a reducing valve 50, and a filter device 60. The shut-off valve 30 opens when the CNG is supplied to the internal combustion engine 11. The shut-off valve 30 closes when the CNG is not supplied to the internal combustion engine 11. If the shut-off valve 30 opens, as for the CNG that has flowed from the CNG tank 21 into the body 40 of the pressure regulator 23, the pressure of the CNG is reduced to a predetermined pressure by the reducing valve 50 after the CNG has passed through the shut-off valve 30. The CNG then flows into the filter device 60. In the filter device 60, foreign matter such as oil contained in the CNG is removed, and then the CNG is drawn into the delivery pipe 24.

The reducing valve 50 includes a substantially cylindrical reducing valve housing 51 with a closed end. The reducing valve housing 51 is attached to the body 40 such that the upper surface of the body 40, which is substantially cuboid, closes the opening of the reducing valve housing 51, which is located at the lower end of the reducing valve housing 51. The reducing valve 50 includes a pressure control chamber 52 in the reducing valve housing 51. The pressure control chamber 52 includes a piston 53 and a reducing valve spring 54, which urges the piston 53 downward, that is, toward the upper surface of the body 40. The body 40 includes a pressure control valve 55, which moves up and down to control the pressure of the CNG.

The filter device 60 is provided below the body 40. The filter device 60 includes a substantially cylindrical drain tank 61 with a closed end. The drain tank 61 is attached to the body 40 such that the lower surface of the body 40 closes the opening of the drain tank 61. The drain tank 61 includes a cylindrical filter 62. The lid member 63 closes the bottom opening of the filter 62, and the lower surface of the body 40 closes the top opening of the filter 62.

An inflow portion 64, which enables the CNG to flow into the drain tank 61, is provided inside the filter 62, and an outflow portion, which enables the CNG to flow out of the drain tank 61, is provided outside the filter 62. In detail, the inflow portion 64 is located radially inward of the filter 62, and the outflow portion 65 is located radially outward of the filter 62. Accordingly, the CNG that has flowed through the inflow portion 64 into the drain tank 61 passes through the filter 62 from the inside to the outside of the filter 62, and then is allowed to flow out of the drain tank 61, that is, out of the pressure regulator 23 through the outflow portion. Foreign matter such as oil caught by the filter 62 when the CNG passes through the filter 62 as described above is accumulated in the drain tank 61.

A communicating hole 67 is formed in the lower end of the side wall of the drain tank 61. The communicating hole 67 is closed by a manual valve 68. The inner circumferential surface of the communicating hole 67 is processed to have an internal thread. The outer circumferential surface of the valve 68 is processed to have an external thread. The external thread is screwed into the internal thread so that the valve 68 is attached to the drain tank 61 and the valve 68 closes the communicating hole 67. When the valve 68 is removed from the drain tank 61, foreign matter such as oil that has been accumulated in the drain tank 61 is drained to the outside of the drain tank 61 through the communicating hole 67.

The side face of the body 40 (right, in FIG. 2) includes a mounting recess 41 as an example of an attaching hole. The shut-off valve 30 is attached to the body 40 such that the tip end of the shut-off valve 30 is inserted into the mounting recess 41. Accordingly, in the pressure regulator 23 according to the present embodiment, the body 40, in which the mounting recess (attaching hole) 41 is formed as described above, serves as “a first component.”

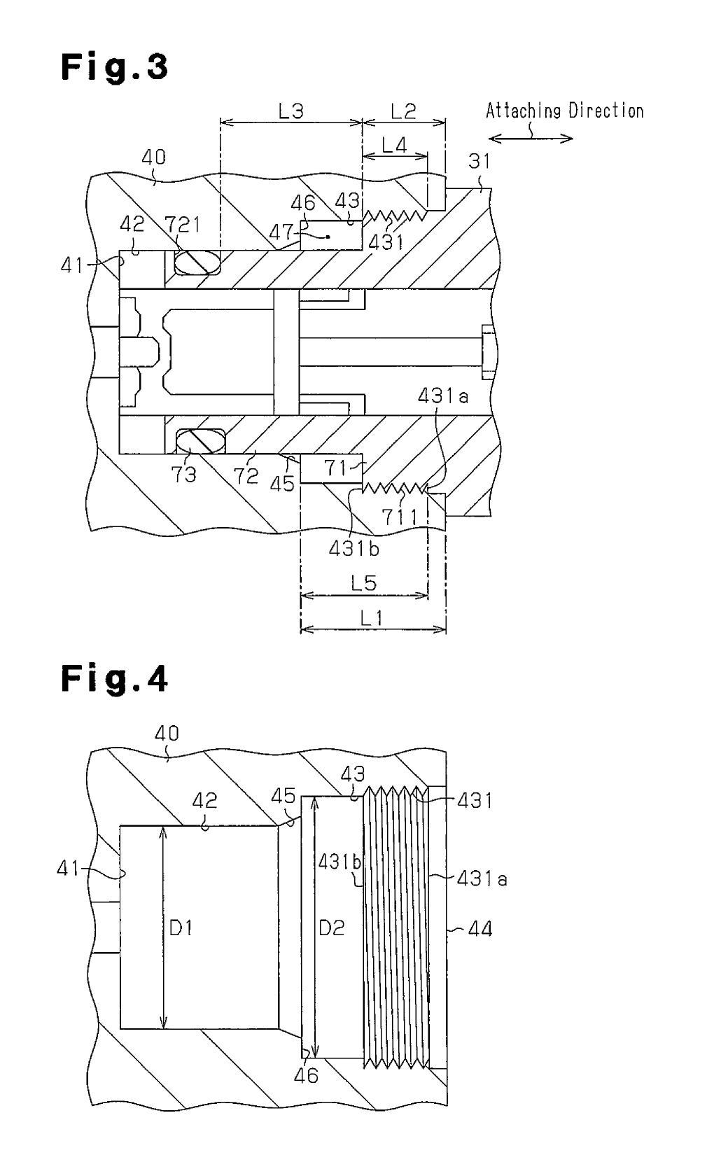

Next, with reference to FIGS. 2 to 4, “the component attaching structure”, which attaches the shut-off valve 30 to the body 40, will be described. The transverse direction in FIGS. 3 and 4 corresponds to “the axial direction of the shut-off valve 30”, and “the attaching direction”, in which the shut-off valve 30 moves relative to the body 40 when the shut-off valve 30 is attached to the body 40.

As depicted in FIGS. 3 and 4, the mounting recess 41 of the body 40 includes a first diameter portion 42 and a second diameter portion 43 that are continuous with each other in the attaching direction. The first diameter portion 42 is located at a position close to the inner end of the second diameter portion 43, that is, to the left of the second diameter portion as viewed in FIGS. 3 and 4. The second diameter portion 43 is in communication with the outside of the body 40 through an opening 44. The diameter D1 of the first diameter portion 42 is less than the diameter D2 of the second diameter portion 43. A part of the first diameter portion 42 that is adjacent to the interface with the second diameter portion 43 serves as an increasing diameter portion 45 having a diameter that gradually increases toward the second diameter portion 43. A part of the inner circumferential surface of the second diameter portion 43 is processed to have an internal thread 431.

As depicted in FIG. 2, the shut-off valve 30 includes a substantially cylindrical shut-off valve housing 31, a hollow bobbin 32 provided to the right of the shut-off valve housing 31 in FIG. 2, and an electromagnetic coil 33 provided in the bobbin 32. The shut-off valve 30 also includes a movable iron core 34, a valve body 35, which is advanced or retracted integrally with the movable iron core 34, a valve seat 36 on which the valve body 35 is seated, and a shut-off valve spring 37, which urges the movable iron core 34 leftward in FIG. 2. The shut-off valve 30 is attached to the body 40 such that the tip end portion of the shut-off valve housing 31, that is, the left portion in FIG. 2 is inserted into the mounting recess 41. Accordingly, in the pressure regulator 23 according to the present embodiment, the shut-off valve housing 31 that is supported by the body 40, which serves as a first component, corresponds to “a second component.”

As depicted in FIG. 3, the shut-off valve housing 31 includes a basal end portion 71 and a distal end portion 72 that is located at a position closer to the tip end (left end in FIG. 3) than the basal end portion 71. The outer diameter of the basal end portion 71 is the same as the diameter D2 of the second diameter portion 43 of the mounting recess 41, and the outer diameter of the distal end portion 72 is the same as the diameter D1 of the first diameter portion 42. The outer circumferential surface of the basal end portion 71 includes an external thread 711, which is screwed into the above internal thread 431.

An annular groove 721 is formed in the entire perimeter of the outer circumferential surface of the distal end portion 72 of the shut-off valve housing 31. The groove 721 accommodates an O-ring 73 as an example of a sealing member, which seals the interface between the outer circumferential surface of the distal end portion 72 of the shut-off valve housing 31 and the inner circumferential surface of the first diameter portion 42 of the mounting recess 41. The O-ring 73 supported by the distal end portion 72 of the shut-off valve housing 31 as described above closely contacts the inner circumferential surface of the first diameter portion 42 of the mounting recess 41 and also closely contacts the bottom surface of the groove 721 of the shut-off valve housing 31.

In the attaching structure for attaching the shut-off valve housing (second component) 31 to the body (first component) 40, the length L1 of the second diameter portion 43 of the mounting recess 41 in the attaching direction is greater than the length L2 of the basal end portion 71 of the shut-off valve housing 31 in the attaching direction. This defines an annular gap 47 between a step 46 and the basal end portion 71 of the shut-off valve housing 31, that is, in the deep portion of the basal end portion 71 in the mounting recess 41. The step 46 is formed between the first diameter portion 42 and the second diameter portion 43.

Further, one of the two ends of the internal thread 431 that is located at a position away from the first diameter portion 42, that is, closer to the opening 44 is defined as an opening end portion 431a, and the other end, which is located at a position closer to the first diameter portion 42, is defined as a deep end portion 43 lb. In this case, the length L3 of the distance between the external thread 711 and the O-ring 73 in the attaching direction is greater than the length L4 of the internal thread 431 and the external thread 711 in the attaching direction, and is also greater than the length L5 from the opening end portion 431 a to the first diameter portion 42 in the attaching direction. The length L4 of the internal thread 431 and the external thread 711 in the attaching direction is less than the length L1 of the second diameter portion 43 in the attaching direction.

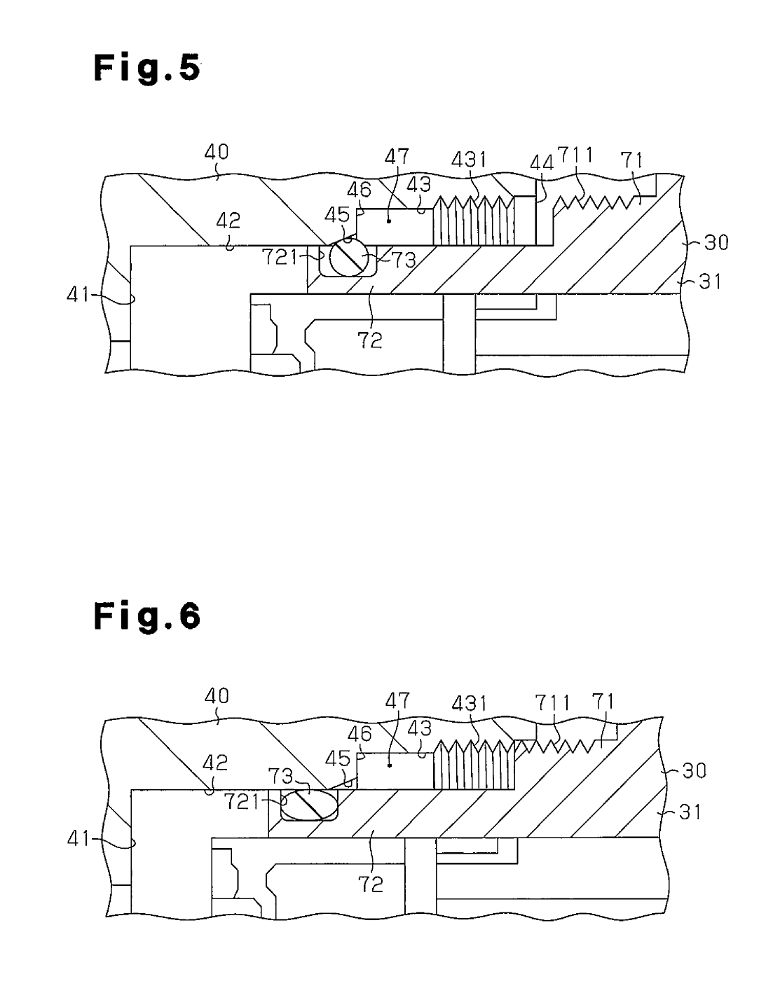

Next, with reference to FIGS. 3, 5, and 6, the operation for attaching the shut-off valve 30 to the body 40 will be described. As depicted in FIG. 5, when attaching the shut-off valve 30 to the body 40, the tip end of the shut-off valve 30 is inserted through the opening 44 into the mounting recess 41. The O-ring 73 supported by the distal end portion 72 of the shut-off valve housing 31 is inserted into the first diameter portion 42 of the mounting recess 41. At this time, since a part of the first diameter portion 42 that is adjacent to the interface with the second diameter portion 43 is formed as the increasing diameter portion 45, even if the O-ring 73 slides on the increasing diameter portion 45, the shut-off valve housing 31, which supports the O-ring 73, is smoothly inserted. When the O-ring 73 passes through the inside of the increasing diameter portion 45 as described above, the O-ring 73 is crushed by the inner circumferential surface of the increasing diameter portion 45 to be gradually deformed.

As depicted in FIG. 6, the O-ring 73 closely contacts the inner circumferential surface of the first diameter portion 42, which is located more deeply than the increasing diameter portion 45. This enables the external thread 711 provided on the outer circumferential surface of the basal end portion 71 of the shut-off valve housing 31 to be screwed into the internal thread 431 provided in the inner circumferential surface of the second diameter portion 43 of the mounting recess 41. When external thread 711 is screwed into the internal thread 431, foreign matter such as chips of material from either component may be generated.

In the component attaching structure in the present embodiment, at the time of starting the screwing of the external thread 711 into the internal thread 431, the O-ring 73 and the inner circumferential surface of the first diameter portion 42 have already been in close contact with each other. When the external thread 711 is screwed into the internal thread 431, the close contact between the O-ring 73 and the inner circumferential surface of the first diameter portion 42 is maintained. Accordingly, the foreign matter generated at the time of screwing does not easily enter the interface between the O-ring 73 and the inner circumferential surface of the first diameter portion 42.

Further, as depicted in FIG. 3, at the time when the screwing of the external thread 711 into the internal thread 431 is completed, the annular gap 47 is defined between the step 46 of the mounting recess 41 and the basal end portion 71 of the shut-off valve housing 31. Accordingly, even if the foreign matter generated at the time of screwing moves deeply in the mounting recess 41, the foreign matter would be accumulated in the gap 47. Therefore, the above foreign matter does not easily enter the interface between the outer circumferential surface of the distal end portion 72 of the shut-off valve housing 31 and the inner circumferential surface of the first diameter portion 42 of the mounting recess 41.

As described above, the above configuration and the operation have the following advantages:

(1) The length L3 of the distance between the external thread 711 and the O-ring 73 in the attaching direction is greater than the length L4 of the internal thread 431 in the attaching direction, and is also greater than the length L5 from the opening end portion 431 a of the internal thread 431 to the first diameter portion 42 in the attaching direction. Accordingly, when attaching the shut-off valve 30 to the body 40, the screwing of the external thread 711 into the internal thread 431 may be started after the O-ring 73 comes into contact with the inner circumferential surface of the first diameter portion 42 of the mounting recess 41. That is, at the start of screwing the external thread 711 into the internal thread 431, the O-ring 73 has already closely contacted the inner circumferential surface of the first diameter portion 42. During the screwing of the external thread 711 into the internal thread 431, the close contact between the O-ring 73 and the inner circumferential surface of the first diameter portion 42 is maintained. Accordingly, the foreign matter generated by the screwing does not easily enter the interface between the inner circumferential surface of the first diameter portion 42 and the O-ring 73. This improves the sealing property between the inner circumferential surface of the mounting recess 41 and the outer circumferential surface of the shut-off valve housing 31.

(2) In the mounting recess 41, the annular gap 47 is defined between the step 46 and the basal end portion 71 of the shut-off valve housing 31. This accumulates the foreign matter that has been generated when the external thread 711 has been screwed into the internal thread 431 in the gap 47 even if the foreign matter deeply moves in the mounting recess 41. This restricts the above foreign matter from entering the interface between the outer circumferential surface of the distal end portion 72 of the shut-off valve housing 31 and the inner circumferential surface of the first diameter portion 42 of the mounting recess 41. This further restricts the above foreign matter from entering the interface between the O-ring 73 and the inner circumferential surface of the first diameter portion 42. This improves the sealing property between the inner circumferential surface of the mounting recess 41 and the outer circumferential surface of the shut-off valve housing 31 as well.

(3) A part of the first diameter portion 42 that is adjacent to the interface with the second diameter portion 43 of the mounting recess 41 is formed as the increasing diameter portion 45. This allows the distal end portion 72 of the shut-off valve housing 31, which supports the O-ring 73, to smoothly enter the first diameter portion 42. This improves the operability of attaching the shut-off valve 30 to the body 40.

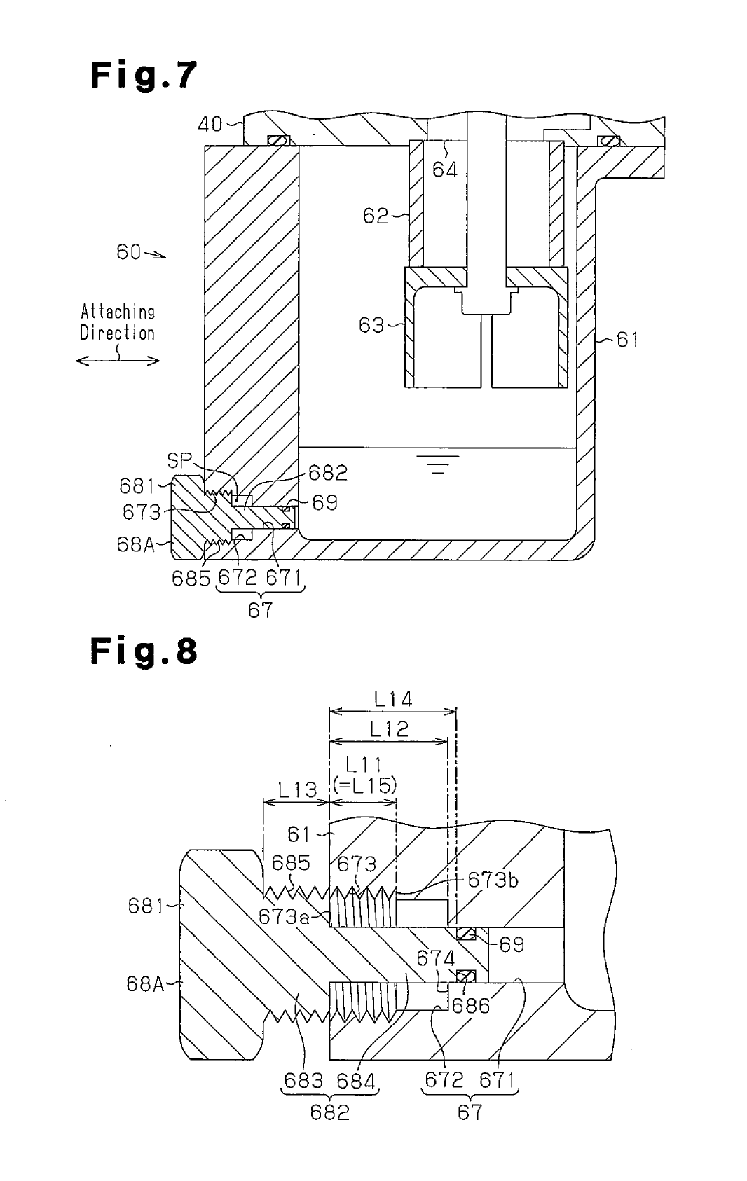

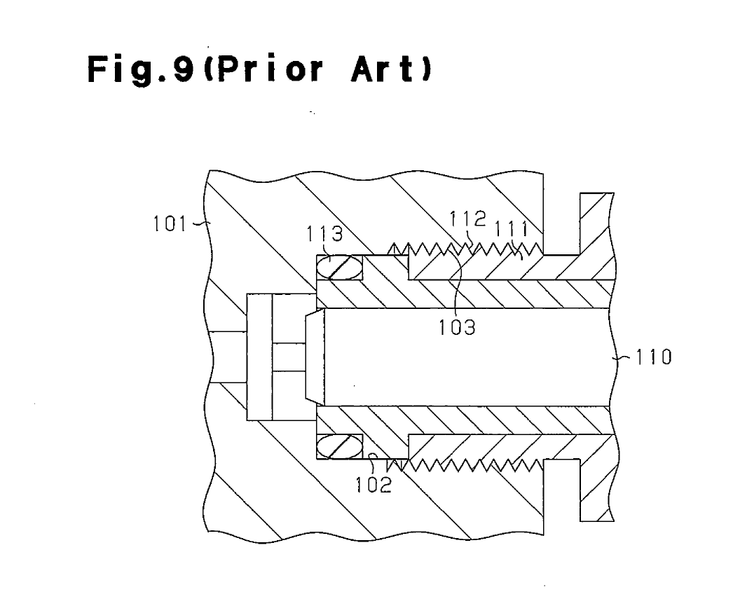

Next, a component attaching structure and a pressure regulator according to a second embodiment will be disclosed according to FIGS. 7 and 8. In the following description, the differences from the first embodiment will mainly be discussed, and like or the same reference numerals are given to those components that are like or the same as the corresponding components of the first embodiment, and the description of the corresponding components will be omitted.

FIG. 7 depicts a part of the pressure regulator 23, that is, a filter device 60 attached to the body 40. As depicted in FIG. 7, a communicating hole 67 is formed in the lower portion of the side wall of the drain tank 61 of the filter device 60. The communicating hole 67 connects the outside and the inside of the drain tank 61. The communicating hole 67 is closed by a valve 68A. The communicating hole 67 closed by the valve 68A as described above corresponds to “an attaching hole”, and the drain tank 61, in which the communicating hole 67 is formed, corresponds to “a first component.” The valve 68A attached to the drain tank 61 corresponds to “a second component”.

The transverse direction in FIG. 7 in which the valve 68A moves relative to the drain tank 61 when attaching the valve 68A to the drain tank 61 is referred to as “attaching direction”.

As depicted in FIGS. 7 and 8, the communicating hole 67 includes a first diameter portion 671 and a second diameter portion 672 that are continuous with each other in the attaching direction. The first diameter portion 671 is located inward from the second diameter portion 672, i.e., right in FIGS. 7 and 8, and opens in the drain tank 61. Further, the second diameter portion 672 opens out of the drain tank 61. The diameter of the second diameter portion 672 is greater than the diameter of the first diameter portion 671.

An internal thread 673 is formed in a part of the inner circumferential surface of the second diameter portion 672. The length L11 of the internal thread 673 in the attaching direction is less than the length L12 of the second diameter portion 672 in the attaching direction. One of the two ends of the internal thread 673 that is located at a position away from the first diameter portion 671 is defined as an opening end portion 673a, and the other end, which is located at a position closer to the first diameter portion 671, is defined as a deep end portion 673b. According to the present embodiment, the position of the opening end portion 673a in the attaching direction is equivalent to a position of the outer opening of the communicating hole 67 in the attaching direction. Accordingly, the length L15 from the opening end portion 673a to the first diameter portion 671 in the attaching direction is the same as the length L12 of the second diameter portion 672 in the attaching direction.

The valve 68A includes a head portion 681 and a shaft portion 682, which extends rightward in FIGS. 7 and 8 from the head portion 681. The shaft portion 682 includes a basal end portion 683 located in the second diameter portion 672, and a distal end portion 684 located to the right of the basal end portion 683 in FIGS. 7 and 8. The diameter of the basal end portion 683 is the same as the diameter of the second diameter portion 672, and the diameter of the distal end portion 684 is the same as the diameter of the first diameter portion 671. The inner circumferential surface of the basal end portion 683 includes an external thread 685, which engages with the internal thread 673.

An annular groove 686 is formed in the entire perimeter of the outer circumferential surface of the distal end portion 684. The groove 686 accommodates an O-ring 69 as a sealing member, which seals the interface between the inner circumferential surface of the communicating hole 67 and the outer circumferential surface of the shaft portion 682 of the valve 68A. In the state where the valve 68A is attached to the drain tank 61, the O-ring 69 closely contacts the inner circumferential surface of the first diameter portion 671 of the communicating hole 67, and also closely contacts the bottom surface of the groove 686.

In the attaching structure according to the present embodiment, the length L13 of the basal end portion 683 of the valve 68A in the attaching direction is the same as the length L11 of the internal thread 673 in the attaching direction, and is less than the length L12 of the second diameter portion 672 in the attaching direction. Further, the length L14 of the distance between the external thread 685 and the O-ring 69 in the attaching direction is greater than the length L11 of the internal thread 673 in the attaching direction, and is also greater than the length L15 from the opening end portion 673a to the first diameter portion 671 in the attaching direction. This defines an annular gap SP between a step 674 and the basal end portion 683 of the valve 68A, that is, in the deep portion of the basal end portion 683. The step 674 is formed between the first diameter portion 671 and the second diameter portion 672.

Next, the operation at the time of attaching the valve 68A to the drain tank 61 will be described. When attaching the valve 68A to the drain tank 61, the shaft portion 682 of the valve 68A is inserted into the communicating hole 67. Even if the tip end of the shaft portion 682 enters the second diameter portion 672 of the communicating hole 67 at this time, the basal end portion 683 of the shaft portion 682 does not enter the second diameter portion 672 in the state where the O-ring 69 is not yet in contact with the inner circumferential surface of the first diameter portion 671. That is, the screwing of the external thread 685 into the internal thread 673 is not yet started.

As shown in FIG. 8, after the O-ring 69 is brought into close contact with the inner circumferential surface of the first diameter portion 671, the screwing of the external thread 685 into the internal thread 673 is started. According to the screwing, the basal end portion 683 enters the second diameter portion 672. When the external thread 685 is screwed into the internal thread 673 as described above, the close contact between the O-ring 69 and the inner circumferential surface of the first diameter portion 671 is maintained. When the screwing of the external thread 685 into the internal thread 673 is completed, the attachment of the valve 68A to the drain tank 61 is completed as well.

As described above, the above configuration and the operation have the following advantages:

(1) In the case of attaching the valve 68A to the drain tank 61, the screwing of the external thread 685 into the internal thread 673 is started after the O-ring 69 comes into contact with the inner circumferential surface of the first diameter portion 671 of the communicating hole 67. Accordingly, the foreign matter generated when the external thread 685 is screwed into the internal thread 673 does not easily enter the interface between the O-ring 69 and the inner circumferential surface of the first diameter portion 671. This improves the sealing property between the inner circumferential surface of the communicating hole 67 and the outer circumferential surface of the shaft portion 682 of the valve 68A.

(2) Further, in the communicating hole 67, the annular gap SP is defined between the step 46 and the basal end portion 683 of the valve 68A. This accumulates the foreign matter that has been generated when the external thread 685 has been screwed into the internal thread 673 in the gap SP even if the foreign matter deeply moves in the communicating hole 67. This restricts the above foreign matter from entering the interface between the outer circumferential surface of the distal end portion 684 of the shaft portion 682 of the valve 68A and the inner circumferential surface of the first diameter portion 671 of the communicating hole 67. This further restricts the foreign matter from entering the interface between the O-ring 69 and the inner circumferential surface of the first diameter portion 671. This improves the sealing property between the inner circumferential surface of the communicating hole 67 and the outer circumferential surface of the shaft portion 682 of the valve 68A as well.

Each of the above embodiments may be modified to other embodiments at least as described below.

In the first embodiment, the increasing diameter portion 45 of a part of the first diameter portion 42 that is adjacent to the interface with the second diameter portion 43 may be omitted. In this case, although the distal end portion 72 of the shut-off valve housing 31, which supports the O-ring 73, is not allowed to easily enter the first diameter portion 42 of the mounting recess 41 in comparison to the first embodiment, the sealing property between the inner circumferential surface of the mounting recess 41 and the outer circumferential surface of the shut-off valve housing 31 is improved as in the first embodiment.

In the first embodiment, as long as the screwing of the external thread 711 into the internal thread 431 is started after the O-ring 73 is brought into close contact with the inner circumferential surface of the first diameter portion 42 of the mounting recess 41, the length L2 of the basal end portion 71 of the shut-off valve housing 31 in the attaching direction may be the same as the length L1 of the second diameter portion 43 in the attaching direction. In this case, although the annular gap 47 is not formed between the step 46 and the basal end portion 71 of the shut-off valve housing 31, the same advantage as advantage (1) above is obtained.

In the first embodiment, the diameter of the mounting recess 41 may be constant. In this case, it is preferable that the outer diameter of a portion of the mounting recess 41, which is located near the tip end of the shut-off valve housing 31, be the same as the outer diameter of a portion of the mounting recess 41, which is located near the basal end of the shut-off valve housing 31. Even in this case, if the length L3 of the distance between the external thread 711 and the O-ring 73 in the attaching direction is greater than the length L4 of the internal thread 431 in the attaching direction, the screwing of the external thread 711 into the internal thread 431 can be started after the O-ring 73 is brought into close contact with the inner circumferential surface of the mounting recess 41 located deeper than the internal thread 431. Therefore, the same advantage as advantage (1) above is obtained.

In the second embodiment, if the screwing of the external thread 685 into the internal thread 673 is started after the O-ring 69 is brought into close contact with the inner circumferential surface of the first diameter portion 671 of the communicating hole 67, the length L13 of the basal end portion 683 of the valve 68A in the attaching direction may be the same as the length L12 of the second diameter portion 672 in the attaching direction. In this case, although the annular gap SP is not located between the step 674 and the basal end portion 683 of the shaft portion 682 of the valve 68A, the same advantage as advantage (4) above is obtained.

In the second embodiment, the diameter of the communicating hole 67 may be constant. In this case, it is preferable that the outer diameter of a portion of the communicating hole 67, which is located near the tip end of the shaft portion 682 of the valve 68A, be the same as the outer diameter of a portion of the communicating hole 67, which is located near the basal end of the shaft portion 682. Even in this case, if the length L14 of the distance between the external thread 685 and the O-ring 69 in the attaching direction is greater than the length L11 of the internal thread 673 in the attaching direction, the screwing of the external thread 685 into the internal thread 673 can be started after the O-ring 69 is brought into close contact with the inner circumferential surface of the communicating hole 67 located deeper than the internal thread 673. Therefore, the same advantage as advantage (4) above is obtained.

Therefore, the present examples and embodiments are to be considered as illustrative and not restrictive and the invention is not to be limited to the details given herein, but may be modified within the scope and equivalence of the appended claims.

1. A component attaching structure for attaching a first component and a second component to each other, wherein
the first component has an attachment hole and an internal thread formed in an inner circumferential surface of the attaching hole,
the second component has an external thread formed on an outer circumferential surface thereof,
the component attaching structure is configured such that the second component can be attached to the first component by screwing the external thread of the second component into the internal thread of the first component,
the second component supports a sealing member, which seals an interface between the outer circumferential surface of the second component and the inner circumferential surface of the attaching hole at a position closer to a tip end of the second component than the external thread, and
if the direction in which the second component moves relative to the first component when the second component is attached to the first component is defined as an attaching direction, a distance between the external thread and the sealing member in the attaching direction is greater than a length of the internal thread in the attaching direction.

2. The component attaching structure according to claim 1, wherein
the attaching hole has a first diameter portion and a second diameter portion having a greater diameter than the diameter of the first diameter portion, wherein the first diameter portion is located deeper than the second diameter portion,
the second component has a basal end portion located in the second diameter portion and a distal end portion located at a position closer to the tip end than the basal end portion to the tip end,
the external thread is formed on the outer circumferential surface of the basal end portion, and the sealing member is supported by the distal end portion, and
the internal thread has two end portions, and if one of the end portions that is located at a position away from the first diameter portion in the attaching direction is defined as an opening end portion, the distance between the external thread and the sealing member in the attaching direction is greater than the length from the opening end portion of the internal thread to the first diameter portion in the attaching direction.

3. The component attaching structure according to claim 2, wherein the length of the second diameter portion in the attaching direction is greater than the length of the basal end portion in the attaching direction.

4. The component attaching structure according to claim 2, wherein a part of the first diameter portion that is adjacent to the interface with the second diameter portion of the attaching hole has a diameter that is gradually increased toward the second diameter portion in the attaching direction.

5. A pressure regulator adapted to be provided in a supply path through which gaseous fuel is supplied to an internal combustion engine, the pressure regulator comprising:
a body having an attaching hole and an internal thread formed in an inner circumferential surface of the attaching hole;
a reducing valve having a housing and an external thread formed in an outer circumferential surface thereof, wherein the reducing valve reduces a pressure of a gas that has flowed into the body;
a shut-off valve, which permits and inhibits the supply of gas to a downstream side, wherein the shut-off valve is attached to the body when the external thread of the shut-off valve is screwed into the internal thread of the body; and
a sealing member, which seals an interface between the inner circumferential surface of the attaching hole and the outer circumferential surface of the housing, wherein
the housing of the shut-off valve supports the sealing member at a position closer to a tip end of the shut-off valve than the external thread to the tip end, and
the distance between the external thread and the sealing member in an axial direction of the shut-off valve is greater than the length of the internal thread in the axial direction.
